(19) United States
(12) Patent Application Publication
(10) Pub. No.: US 2009/0256319 A1
(43) Pub. Date: Oct. 15, 2009

(54) QUICK CHANGE CHUCK WITH LED LIGHTING

(76) Inventors: Daniel R. Seymour, Mooresville, NC (US); Brandon C. Hoover, Cornelius, NC (US); James M. Burry, Troutman, NC (US)

Correspondence Address: RONALD L. HOFER, 122 LINDBERGH LANE, MOORESVILLE, NC, 28117, US

(21) Appl. No.: 12/421,250

(22) Filed: Apr. 9, 2009

Related U.S. Application Data
(60) Provisional application No. 61/123,447, filed on Apr. 9, 2008.

(51) Int. Cl. B23B 31/12; B23B 31/00; F21V 33/00

(52) U.S. Cl. 279/75; 279/142; 362/253; 362/234

(57) ABSTRACT

A quick change tool chuck has a housing with an LED light source incorporated therein, the housing being coaxially located about a quick change driver bit chuck. The housing can have two LED lamps which are focused at the end of an associated bit.

### FIELD OF THE INVENTION

The present invention relates to a tool chuck. More particularly, a preferred embodiment of the present invention relates to a quick change chuck that incorporates a light emitting diode (LED) to provide illumination of the work piece.

### BACKGROUND OF THE INVENTION

It is desirable to have good lighting conditions when working with power tools such as battery operated drills both to ensure accurate use of the tool and also for safety reasons. However, there remains room for improvements to help the users of such devices. For example, not all battery operated drills incorporate a light source. Also, to obtain good lighting conditions, the light source must be able to provide sufficient illumination to the work area. This requires that the light source either be relatively bright or that the light source be located close to the work area and that the light source be focused on the work area to maximize the amount of light reaching the work area.

It is typical for users to require a flashlight or drop light while working in tight, confined, low-light, night time, or power-out conditions. It would be desirable to have a tool which itself incorporated a light source which enabled users to see their work piece in low light conditions.

Several currently commercially available battery operated drills have an LED located on the body of the drill, but they only illuminate when the motor of the drill is operating. Thus, if the user wants to illuminate the work piece, the motor must be operated which not be desirable in many situations and may be a waste of battery power. It would be desirable to have a light source which could be switched on independently of the drill motor. Thus, it would be desirable to have an LED light which was incorporated into a part of the drill but which could be controlled independently of the drill motor.

Furthermore, most battery operated drills do not have a quick change chuck and changing drill or screw driver bits in such drills requires more time and is somewhat more difficult than would be the case with a quick change chuck. While so called quick change chucks are known, there is room for improvement in their ease of manipulation. Conventional quick change chucks generally require the user to use one hand to move a collar to position the chuck mechanism to receive a bit while simultaneously using another hand to insert a bit into the chuck mechanism. While such quick change chucks are easier to manipulate than conventional chucks, it would be desirable to have a quick change chuck which is even easier to manipulate.

Accordingly, a preferred embodiment of the present invention provides a quick change chuck with an LED light which has an independent power switch enabling the user to illuminate the work piece at any time. The chuck also incorporates a novel quick change mechanism which allows the user to quickly and easily change bits such as screw driver type bits. Further understanding of the present invention will be had from the accompanying drawings taken in conjunction with the following specification and claims.

### SUMMARY OF THE INVENTION

In one preferred embodiment of this invention, a tool chuck has a housing with at least one LED light source incorporated therein, the housing being coaxially located about a quick change driver bit chuck. In another preferred embodiment, the housing has two LED lights which are aimed at the end of an associated driver bit.

### BRIEF DESCRIPTION OF THE DRAWINGS

FIG. 1 is a perspective view of a preferred embodiment of a drill chuck of the present invention;

FIG. 2 is an exploded view of a the drill chuck of FIG. 1;

FIG. 3 is a plan view of the drill chuck of FIG. 1 showing the manual switch for the LED light;

FIG. 4 is a side elevational view of the drill chuck of FIG. 1;

FIG. 5 is a bottom elevational view of the drill chuck of FIG. 1;

FIG. 6 is a perspective view of an LED light assembly of the drill chuck of FIG. 1;

FIG. 7 is an exploded view of the LED light assembly of FIG. 6;

FIG. 8 is a sectional view taken along lines 8-8 in FIG. 1;

FIG. 9 is a sectional view taken along lines 9-9 in FIG. 1;

FIG. 10 is a sectional view as in FIG. 8 but with a driver bit inserted into the quick change drill chuck;

FIG. 11 is a sectional view as in FIG. 9 but with a driver bit inserted into the quick change drill chuck;

FIG. 12 is a perspective view of an alternate embodiment of a quick change chuck of the present invention;

FIG. 13 is a partially exploded view of the chuck of FIG. 12;

FIG. 14 is a partially exploded view of the quick change chuck mechanism of FIGS. 1-16;

FIG. 15 is a sectional view taken along line 15-15 in FIG. 12 with a driver bit partially inserted therein; and

FIG. 16 is a sectional view taken along line 16-16 in FIG. 12 with a driver bit fully inserted therein.

### DESCRIPTION OF THE INVENTION

Now referring to the Figures, a preferred embodiment of a quick change LED chuck of the present invention is shown and indicated generally by the numeral 10. Generally speaking quick change LED chuck 10 comprises chuck housing 12, light assemblies 14 and 16 and quick change chuck mechanism 18.

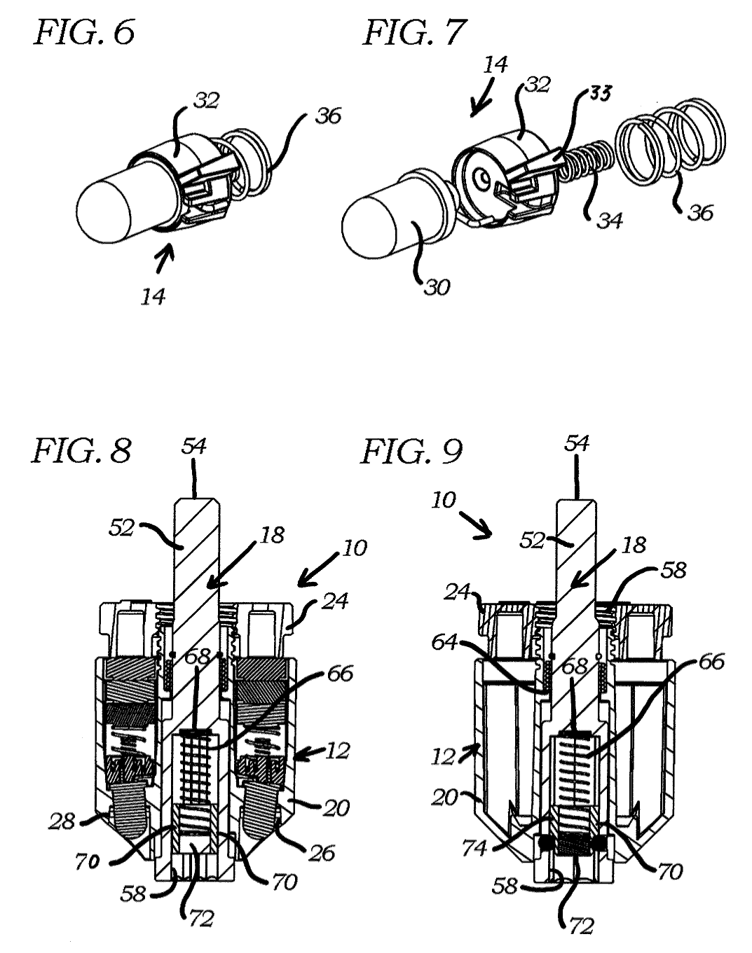

Housing 12 is somewhat cylindrical in form having body 20 with flutes 22 for easier manipulation thereof and a round cap 24 which somewhat seals the hollow interior of housing 12 and can be rotated by the user to switch light assemblies 14 and 16 on or off. Light assemblies 14 and 16 fit closely into corresponding apertures 26 and 28 in body 20 of chuck housing 12. As is best shown in FIGS. 6 and 7, light assembly 14 has an LED (light emitting diode) 30, LED holder 32 with location wings 33 and spring 34 and 36. In series above LED 30 are three button type batteries 38, 40, and 42 in polymeric tubing 44. Light assembly 16 is analogous to light assembly 14 and includes LED 46. Cap 24 is threaded onto the upper part of body 20 of housing 12 so that the user can rotate cap 24 with respect to body 20 to connect or disconnect electrical circuits between the respective batteries and LEDs. Body 20 of housing 12 and cap 24 can be constructed of aluminum, plastic or any other suitable material. Of course, while a particular switch means is shown and described it will be appreciated by those skilled in the art that other switch designs can be used in the present invention and such other alternative switches are intended to be within the broad scope of the present invention. For example the switch could alternatively be a sliding switch, a cam switch, a push button or any other device for selectively connecting and disconnecting the electrical circuits.

LEDs 30 and 46 are located in apertures 26 and 28 in chuck body 20 and are aimed to point in the direction of the end of a typical screw driver type bit 50. Preferably the focus of the LEDs is at the end point of a bit which has been inserted into the quick change chuck. It has been found that the LEDs are so focused when they are focused inwardly about 5 degrees from the being parallel to the shaft of the bit. Of course, a multitude of bits can be used with the present invention including screw driver bits of various types such as phillips, flat, and the like. Preferably, LEDs 30 and 46 are focused in a binocular manner so that their beams cross at the point of the work piece surface where the drill bit or screw driver bit is to contact.

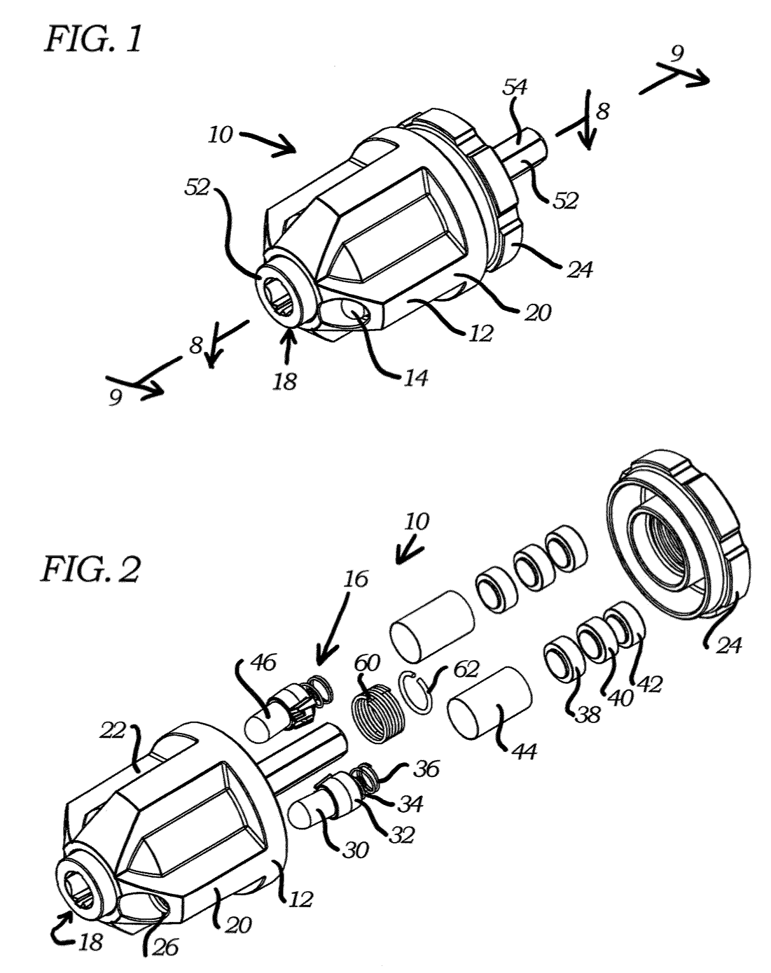

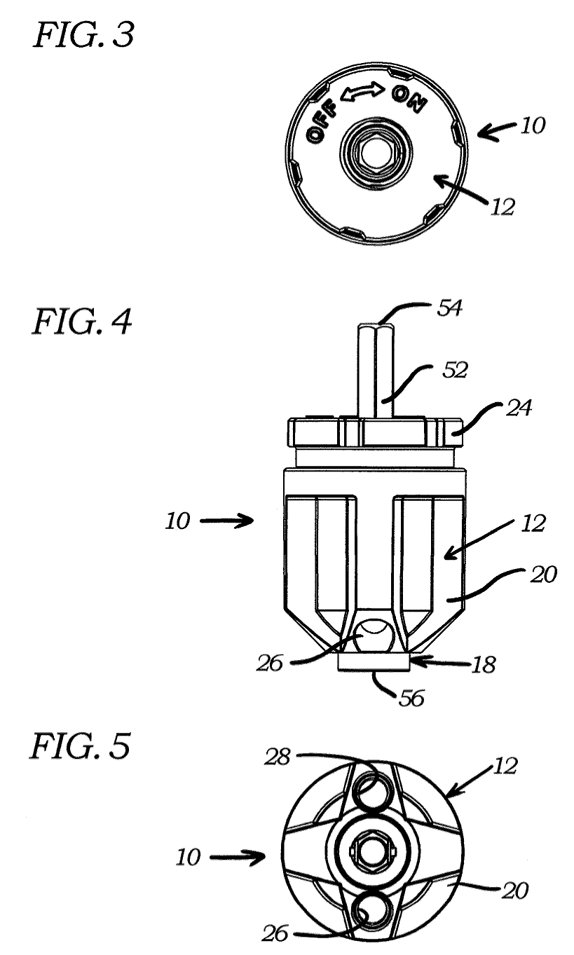

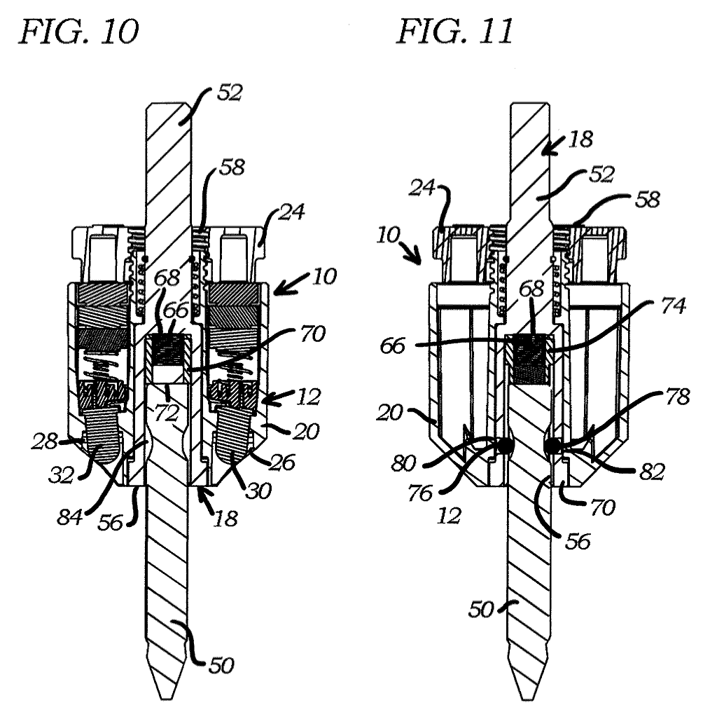

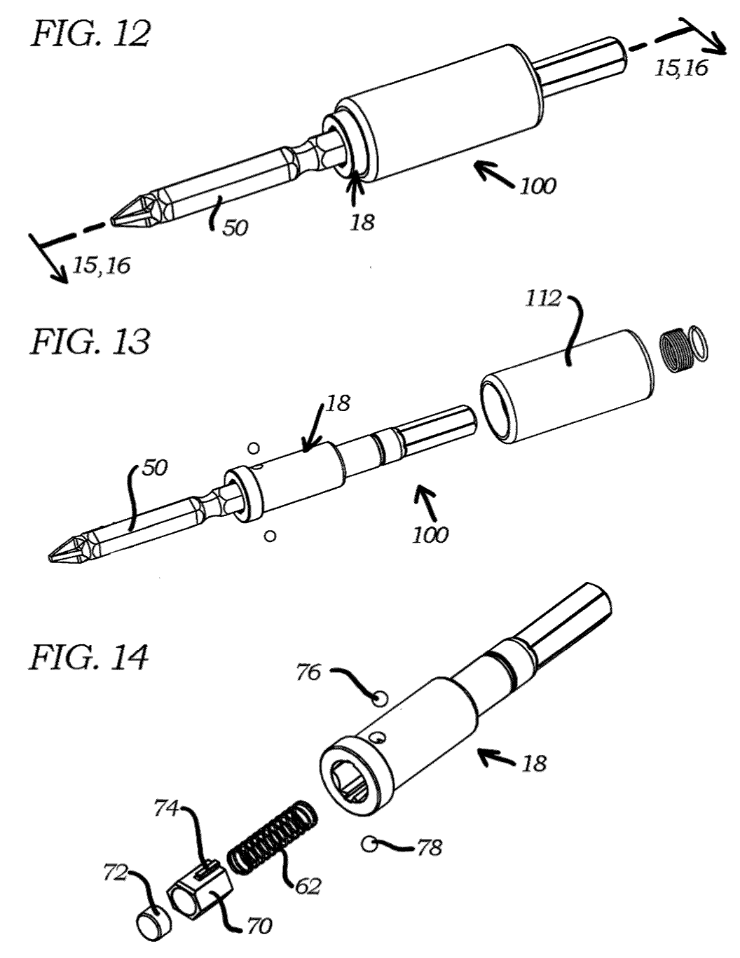

Quick change chuck 18 has a shaft 52, one end of which is intended for operative attachment to a suitable chuck or the like of a power drill or other suitable tool. The opposite end portion 56 of shaft 52 has a bore 58 for selectively receiving and retaining interchangeable bits 50. First spring 60 is coaxial about the shaft 52 and is positioned to be in compression between spring clip 62 and shoulder 64 of housing 20. First spring 60 functions to urge housing 12 to the left as viewed in FIGS. 1 and 2 or downwardly as viewed in FIGS. 8-11.

Located inside bore 58 is second spring 66 which is positioned to be in compression between bottom surface 68 of bore 58 and sliding plunger 70. Sliding plunger 70 held in bore 58 carries magnet 72 at its forward end for attracting bits thereagainst. Sliding plunger 70 has laterally extending keys 74 which slidingly fit into corresponding keyways in bore 58 of shaft 52. Sliding plunger 70 is held in bore 58 by ball bearings 76 and 78 which abut against keys 74. Ball bearings 76 and 78 are located in somewhat conically tapered holes 80 and 82 respectively.

In operation, the user inserts the end of a bit 50 into the open end of bore 58 and continues to apply pressure against magnet 72 and hence plunger 70 to move plunger 70 upwardly against second spring 66 until ball bearings 76 and 78 are proximate to indentation 84 in bit 50. The bit will automatically lock in place. To release the bit, the user simply pulls back on housing 12 and the bit will release. The bit will be held by magnet 72 to ensure the bit does not fall to the ground after being released. Thus, the user does not need to pull a collar or other mechanism to set the quick change chuck mechanism 18 to a “ready” or “unloaded” configuration in order to insert a bit therein but can readily insert a bit into quick change chuck 10 using only one hand, which feature will be appreciated by those skilled in the art.

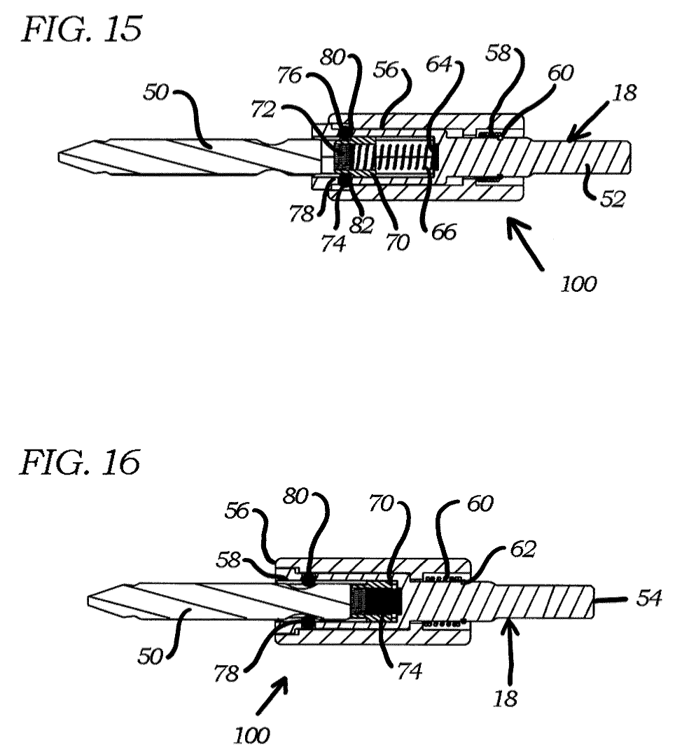

FIGS. 13-16 illustrate and alternative embodiment of the present invention, indicated generally by the numeral 100, which does not have the LED light feature of the previously described embodiment. Chuck 100 has housing 112 which is of a different design than housing 12 and has quick change chuck 18 which is of the same design as quick change chuck 18 of quick change LED chuck 10.

The LED Quick Change Chuck has many desired features which will be useful to end users in low light situations. It does not require the user to carry an additional outside power source and creates a brightly lit work area. These and other advantages of the present invention will be apparent to those skilled in the art.

The present invention is subject to variation and modification and such variations and modifications are intended to be within the broad scope of the present invention which is to be limited only by the appended claims.

What is claimed is:

1. A quick change chuck having a housing and an elongated shaft, said housing having a tubular interior for receiving a portion of said shaft and said shaft having a longituidinally extending bore with a plunger slidingly desposed therein, said plunger having a pair of laterally extending keys which slidingly fit into corresponding keyways in said bore and said chuck having a pair of ball bearings located by respective holes in a wall of said bore, said ball bearings adapted to abut against said keys when said plunger is in its unloaded position and to abut against an indentation in an associated bit to retain said bit when said bit has been loaded into said bore.

2. A quick change chuck as in claim 1 having an LED light source positioned therein.

3. A quick change chuck as in claim 2 having a generally cylindrical housing with an upper end and a lower end, said housing having at least one aperture in said lower end for receiving an LED and said drill chuck including an LED located within said one aperture.

4. A quick change chuck as in claim 3 wherein said housing has two said apertures and two said LEDs and said LEDs are focused in a binocular manner to provide intersecting light beams.

5. A quick change chuck as in claim 4 wherein said light beams intersect at a point proximate to an end of a bit inserted therein.

7. A quick change chuck as in claim 5 wherein said chuck has a switch for switching an LED light source on and off.
